(19) United States
(12) Patent Application Publication
(10) Pub. No.: US 2017/0257916 A1
(43) Pub. Date: Sep. 7, 2017

(54) LIGHTING DEVICE

(71) Applicant: SHARP KABUSHIKI KAISHA, Sakai City, Osaka (JP)

(72) Inventor: Ken SUMITANI, Sakai City, Osaka (JP)

(73) Assignee: SHARP KABUSHIKI KAISHA, Sakai City, Osaka (JP)

(21) Appl. No.: 15/506,568

(22) PCT Filed: Jun. 18, 2015
(86) PCT No.: PCT/JP2015/067563

§ 371 Date: Feb. 24, 2017

(30) Foreign Application Priority Data
Aug. 27, 2014 (JP) 2014-172338

(51) Int. Cl. H05B 33/08

(52) U.S. Cl. CPC H05B 33/0815; H05B 33/0827; H05B 33/089; H05B 33/0845; H05B 33/0857

(57) ABSTRACT

A lighting device includes a plurality of light sources, a power supply circuit that generates a power supply voltage on the basis of a voltage which is output from an external power supply, and a control circuit that is driven by the power supply voltage. The control circuit detects a drop in the power supply voltage and controls lighting states of the plurality of light sources on the basis of the detection. The power supply voltage is supplied to all or a portion of the plurality of light sources.

### TECHNICAL FIELD

The present invention relates to a lighting device that includes a light emitting element, such as a light emitting diode (hereinafter, referred to as an LED), as a light source.

### BACKGROUND ART

Instead of incandescent lamps or fluorescent lamps that have been used hitherto, the proportion of LEDs has rapidly increased in recent years as light sources used for lighting devices. In general households, a commercial AC power supply has been often used, but most of LEDs are driven by a direct current. Thus, power supply devices for obtaining a direct current from the AC power supply have been built into the lighting devices or have been separately provided.

The operation of a general LED lighting device of the related art will be described with reference to FIG. 11. An LED lighting device 1100 illustrated in FIG. 11 is an example of a lighting device functioning by turning on an LED group 140 serving as a light emitting element by using an AC voltage which is output from an AC power supply 101. Note that the configuration and functions thereof are simplified for convenience of description.

The AC power supply 101 is a commercial AC power supply for a general household of, for example, AC 100 V/60 Hz. The power supply circuit 110 converts the AC voltage, which is output from the AC power supply 101, into a DC voltage and applies the DC voltage between an anode line 111 and a cathode line 112 to thereby drive and turn on the LED group 140. In the drawing, the LED group 140 constituted by ten LEDs being connected to each other in series is illustrated. However, the number of series connections thereof and the number of parallel connections thereof may vary as needed, or a single LED may be used. In many cases, an LED is driven by a direct current. Therefore, the power supply circuit 110 is a DC power supply generating a predetermined amount of DC power on the basis of AC power which is output from the AC power supply 101.

Next, the operation of an LED lighting device of the related art which has a color changeover function will be described with reference to FIG. 12. An LED lighting device 1200 illustrated in FIG. 12 has a function of changing a color temperature of emitted light by turning off the supply of power from an AC power supply 101 to an LED lighting device 1200 and by turning on the supply of power from the AC power supply 101 to the LED lighting device 1200 again within a predetermined time period. A power switch SW1 is used for the changeover of a color temperature, and thus there is an advantage in that particular control means is not necessary other than the power switch SW1.

The LED lighting device 1200 illustrated in FIG. 12 includes an LED group 141 and an LED group 142 that are differ in color temperature. It is possible to obtain emitted light beams having different color temperatures by selectively turning on any LED group. Regarding the LED group 141 and the LED group 142, the anode sides thereof are connected to a common anode line 111, but the cathode sides thereof are connected to different lines of a cathode line 131 and a cathode line 132, respectively. A changeover circuit 130 electrically connects one of the cathode line 131 and the cathode line 132 to a cathode line 112. A predetermined amount of DC power is supplied between the anode line 111 and the cathode line 112 by a power supply circuit 110, and only an LED group having a cathode side being electrically connected to the cathode line 112 is turned on by the changeover circuit 130.

The control circuit 120 controls the changeover circuit 130 by using changeover signal lines 121 and 122. That is, which one of the cathode line 131 and the cathode line 132 is electrically connected to the cathode line 112 is determined by the control circuit 120. The control circuit 120 monitors the voltage of a monitoring line 102 having the same potential as that of one node of the AC power supply 101 when the switch SW1 is set to be in an on-state, to thereby detect the ON/OFF of the supply of power from the AC power supply 101 to the LED lighting device 1200. The control circuit 120 changes over an LED group to be turned on by using the changeover signal lines 121 and 122 when the supply of power from the AC power supply 101 to the LED lighting device 1200 is turned off and the supply of power from the AC power supply 101 to the LED lighting device 1200 is turned on again within a predetermined time period.

A power supply voltage for operating the control circuit 120 is generated by a power supply circuit 150. The power supply circuit 150, which is a power supply circuit including a rectifier or smoothing means, converts an AC voltage which is output from the AC power supply 101 into a DC voltage necessary for the operation of the control circuit 120, and supplies the DC voltage to the control circuit 120. The power supply circuit 150 includes a capacitor in order to hold the generated DC voltage for a certain period of time so that the supply of power from the power supply circuit 150 to the control circuit 120 is not stopped at the same time when the supply of power from the AC power supply 101 to the LED lighting device 1200 is turned off.

With such a configuration, the LED lighting device 1200 can realize a desired color temperature changeover function.

Examples of the control circuit 120 and the changeover circuit 130 that are used in the LED lighting device 1200 will be described with reference to FIG. 13.

Power supply lines 1401 and 1402 providing a DC voltage for driving the control circuit 120 are equivalent to power supply lines 151 and 152, respectively, in the LED lighting device 1200 illustrated in FIG. 12. A microcontroller 210 operates using a voltage applied between the power supply line 1401 and the power supply line 1402 as a power supply voltage.

A node N1 is a node for the microcontroller 210 to determine a voltage level. The voltage of the node N1 is set by a diode D2, a resistor R1, and a resistor R2 which are connected to the monitoring line 102 in series and a capacitor C4 which is connected to the resistor R2 in parallel, and is used to determine the ON/OFF of the supply of power from the AC power supply 101 to the LED lighting device 1200. The capacitor C4 is provided to suppress the ripple of an alternating current and to prevent a fluctuation occurring due to noise. When the supply of power from the AC power supply 101 to the LED lighting device 1200 is turned off, the voltage of the node N1 is set to be less than a predetermined level. On the other hand, in a case where the supply of power from the AC power supply 101 to the LED lighting device 1200 is turned on, the voltage of the node N1 is set to be equal to or higher than the predetermined level.

The microcontroller 210 changes over voltage levels of the changeover signal lines 121 and 122 in order to select an LED group to be turned on by detecting the ON/OFF of the supply of power from the AC power supply 101 to the LED lighting device 1200, and sets any one of the changeover signal lines to be at a High level and sets the other one to be at a Low level.

The changeover circuit 130 sets a switching element Q1 to be in an off-state when the changeover signal line 122 is at a High level and sets the switching element Q1 to be in an on-state when the changeover signal line 122 is at a Low level by using resistors R3 to R6, a photocoupler PC1, and the switching element Q1. In addition, the changeover circuit 130 sets a switching element Q2 to be in an off-state when the changeover signal line 121 is at a High level and sets the switching element Q2 to be in an on-state when the changeover signal line 121 is at a Low level by using resistors R7 to R10, a photocoupler PC2, and the switching element Q2. In the example illustrated in FIG. 13, an N-type MOS-FET is used as the switching elements Q1 and Q2. By the operation of these components, the cathode line 131 is electrically connected to the cathode line 112 when the changeover signal line 121 is at a High level and the changeover signal line 122 is at a Low level, thereby turning on the LED group 141. The cathode line 132 is electrically connected to the cathode line 112 when the changeover signal line 121 is at a Low level and the changeover signal line 122 is at a High level, thereby turning on the LED group 142.

The photocoupler is used for the changeover circuit 130 because there is a large difference in potential between a voltage between the power supply line 1401 and the power supply line 1402 (voltage between the power supply line 151 and the power supply line 152) which serves as a power supply voltage of the microcontroller 210 and a voltage between the anode line 111 and the cathode line 112 which is generated by the power supply circuit 110 or because the voltages are insulated from each other.

The microcontroller 210 requires specifications including the provision of a comparator or an AD converter for determining the voltage level of the node N1 and the provision of general-purpose output terminals for outputting a High-level voltage or a Low-level voltage to the changeover signal lines 121 and 122. In addition, since the microcontroller 210 operates for a long time as much as possible with a voltage held in the capacitor C4 by using the voltage provided at the node N1 as a power supply voltage, it is preferable that the microcontroller operate in a relatively wide power supply voltage range and have low current consumption. Further, it is preferable that the microcontroller 210 include an oscillator and have a reset function in order to be reliably reset during a drop in power supply voltage. These functions can also be adequately realized by a low-cost 8-bit microcontroller. The same functions can be realized by a general-purpose logic circuit without using a microcontroller.

Next, an LED lighting device 1400 having the same functions as those of the LED lighting device 1200 will be described with reference to FIG. 14. The LED lighting device 1400 simplifies the generation of a driving power supply for the control circuit 120 by using a node within the power supply circuit 110.

The power supply circuit 110 includes a power supply generation circuit 170 that converts an AC voltage, which is output from an AC power supply, into a DC voltage, a current control circuit 190 that controls a current for driving the LED groups 141 and 142, and a power supply IC 180 for controlling the current control circuit 190. The current control of an LED requires processing such as the detection of an open-circuit/short-circuit or other processing against error, and thus, miniaturization, cost reduction, and design facilitation are achieved using a power supply IC having desired functions in many cases, rather than using discrete components. The power supply IC has various specifications, requires a logic voltage for a logical operation in many cases, and generally uses a direct current of approximately 9 to 30 V. The power supply IC 180 uses a control node line group 181 provided as needed, and controls a current for driving the LED groups 141 and 142 by the current control circuit 190. The power supply generation circuit 170 converts an AC voltage, which is output from an AC power supply, into a DC voltage by using a rectifier or a smoothing circuit, and applies the DC voltage between a power supply line 171 and a reference potential line 172. In addition, the power supply generation circuit 170 generates a driving voltage Vcc for driving the power supply IC 180 by using a voltage dropping circuit or a voltage transformation circuit, or by using a transformer or the like as needed, and applies the driving voltage Vcc to a power supply line 173. Meanwhile, the power supply generation circuit 170 and the current control circuit 190 are illustrated in the drawing so as to be clearly separated from each other for description of functions thereof. However, actually, the circuits cannot be clearly separated from each other in many cases. For example, a mixed configuration, such as the generation of the driving voltage Vcc for driving the power supply IC 180 using a transformer at the same time when transformation is performed using the same transformer in order to control a current for driving the LED groups 141 and 142, is often adopted in order to perform the overall functions.

A power supply voltage required to drive the control circuit 120 in the LED lighting device 1400 is generated by a power supply generation circuit 160 on the basis of the driving voltage Vcc generated by the power supply generation circuit 170 for the operation of the power supply IC 180, rather than being independently generated from an AC voltage as in the LED lighting device 1100. The control circuit 120 is driven by a power supply voltage, which is generated by the power supply generation circuit 160 and is applied to a power supply line 161, and a reference potential which is generated by the power supply generation circuit 170 and is applied to the reference potential line 172. Other operations in the LED lighting device 1400 are the same as those in the LED lighting device 1100.

An example of the power supply generation circuit 160 is illustrated in FIG. 15. A three-terminal regulator U1 generates a power supply voltage necessary for the operation of the control circuit 120 from the driving voltage Vcc (may be a direct current of approximately 9 to 30 V in many cases) which is generated for the operation of the power supply IC 180 and is applied to the power supply line 173, and applies the generated power supply voltage to the power supply line 161. The power supply voltage generated by the three-terminal regulator U1 is often a direct current of approximately 1.5 to 5 V for the operation of the control circuit 120 that generally has a built-in microcontroller. Therefore, the function of the power supply generation circuit 160 is to simply drop a voltage, and a three-terminal regulator is easily used as in the example illustrated in FIG. 15. A diode D1 and a capacitor C3, which are provided on an output side of the three-terminal regulator U1, are provided to prevent back-flow of current and to hold a voltage when the supply of power from the AC power supply 101 to the power supply generation circuit 170 is turned off, and to operate the control circuit 120 for a while even when the driving voltage Vcc to be applied to the power supply line 173 drops.

As described above, two examples of an LED lighting device capable of changing a color temperature by operating only the power switch SW1 have been described. As another example, PTL 1 also discloses an LED lighting device that changes over a color temperature by the ON/OFF of the supply of power from an AC power supply to the LED lighting device. In addition, PTL 2 also discloses an LED lighting device changing over a lighting state of an LED group by phase light control, rather than performing changeover according to the ON/OFF of the supply of power from an AC power supply to the LED lighting device, and has a configuration similar to that in PTL 1.

### CITATION LIST

### Patent Literature

PTL 1: Japanese Unexamined Patent Application Publication No. 2014-7164

PTL 2: Japanese Unexamined Patent Application Publication No. 2010-205738

### SUMMARY OF INVENTION

### Technical Problem

Also in the related art, an LED lighting device capable of changing over a color temperature and brightness by changing over a light emission device by the ON/OFF of the supply of power from an AC power supply to the LED lighting device is realized. However, a power supply circuit is required to be added or changed, which results in an increase in the degree of difficulty in design. In a case where the power supply circuit is added, the prevention of noise, safety measures, and the like are individually required, which results in a significant increase in the number of components. In a case where the power supply circuit is changed, the power supply circuit has to be changed with great attention so as not to have an adverse effect, after fully knowing the operation of the power supply circuit before the change. In any case, since an insulating means or a level shift circuit is required for changeover in many cases, the number of components is increased, which results in increases in size and cost.

The invention is contrived in view of such situations, and an object thereof is to provide a lighting device capable of performing transition between lighting states of a plurality of light sources by the ON/OFF of the supply of power from an external power supply to an LED lighting device with a simple configuration.

### Solution to Problem

In order to accomplish the above-described object, a lighting device according to the invention is configured (first configuration) to include a plurality of light sources, a power supply circuit that generates a power supply voltage on the basis of a voltage which is output from an external power supply, and a control circuit that is driven by the power supply voltage, in which the control circuit detects a drop in the power supply voltage and controls lighting states of the plurality of light sources on the basis of the detection, and the power supply voltage is supplied to all or a portion of the plurality of light sources.

In the lighting device having the above-described first configuration, it is preferable to adopt a configuration (second configuration) in which the control circuit includes a detection unit that detects a drop in the power supply voltage, and a voltage generation unit that generates a power supply voltage for the detection unit for driving the detection unit on the basis of the power supply voltage, and the voltage generation unit has a capacity for holding the power supply voltage for the detection unit.

In the lighting device having the above-described first or second configuration, it is preferable to adopt a configuration (third configuration) in which the control circuit includes a discharging element that discharges the power supply voltage and is not included in the detection unit and the voltage generation unit.

In the lighting device having any one of the above-described first to third configurations, it is preferable to adopt a configuration (fourth configuration) in which the control circuit sets selection states of the plurality of light sources to be a first selection state in an initial state, makes the selection states of the plurality of light sources transition to another selection state in a case where a first time period elapses after a drop in the power supply voltage is detected, and sets the selection states of the plurality of light sources to be the first selection state in a case where a second time period longer than the first time period elapses after a drop in the power supply voltage is detected.

In the lighting device having any one of the above-described first to fourth configurations, it is preferable to adopt a configuration (fifth configuration) in which the power supply circuit adjusts a value of an output current in accordance with a light control signal.

In the lighting device having the fifth configuration, it is preferable to adopt a configuration (sixth configuration) in which the control circuit generates the light control signal.

In the lighting device having the sixth configuration, it is preferable to adopt a configuration (seventh configuration) in which the light control signal is supplied from the outside, and the power supply circuit prioritizes either of the contents of the light control signal generated by the control circuit and the contents of the light control signal supplied from the outside in a case where the contents do not conform to each other.

### Advantageous Effects of Invention

According to the lighting device of the invention, it is possible to perform transition between lighting states (color temperature or brightness) of the plurality of light sources by the ON/OFF of the supply of power from an external power supply to an LED lighting device with a simple configuration.

The lighting device according to the invention has a simple configuration, and thus it is possible to drastically suppress an increase in the number of components, an increase in circuit size, and an increase in cost, as compared to the above-described lighting device of the related art which has a lighting state transition function. In addition, the lighting device according to the invention has a particularly simple design, and thus can also be realized without changing the power supply circuit of the above-described lighting device that does not have a lighting state transition function.

### BRIEF DESCRIPTION OF DRAWINGS

FIG. 1 is a diagram illustrating a configuration of a lighting device according to a first embodiment of the invention.

FIG. 2 is a diagram illustrating examples of a control circuit and a changeover circuit which are used in an LED lighting device illustrated in FIG. 1.

FIG. 3 is a diagram illustrating another example of the control circuit used in the LED lighting device illustrated in FIG. 1.

FIG. 4 is a diagram illustrating an example of the transition of a lighting state of the lighting device illustrated in FIG. 1.

FIG. 5 is a diagram illustrating another example of the transition of a lighting state of the lighting device illustrated in FIG. 1.

FIG. 6 is a timing chart illustrating the operation of the lighting device illustrated in FIG. 1.

FIG. 7 is a diagram illustrating a configuration of a lighting device according to a second embodiment of the invention.

FIG. 8 is a diagram illustrating a configuration of a lighting device according to a third embodiment of the invention.

FIG. 9 is a diagram illustrating a configuration of a lighting device according to a fourth embodiment of the invention.

FIG. 10 is a diagram illustrating an example of the transition of a lighting state of the lighting device illustrated in FIG. 9.

FIG. 11 is a diagram illustrating an example of a configuration of a lighting device of the related art.

FIG. 12 is a diagram illustrating an example of a configuration of a lighting device of the related art which has a color changeover function.

FIG. 13 is a diagram illustrating examples of a control circuit and a changeover circuit which are used in a LED lighting device illustrated in FIG. 12.

FIG. 14 is a diagram illustrating another example of a configuration of the lighting device of the related art which has a color changeover function.

FIG. 15 is a diagram illustrating an example of a power supply generation circuit which is used in an LED lighting device illustrated in FIG. 14.

### DESCRIPTION OF EMBODIMENTS

Hereinafter, embodiments of the invention will be described with reference to the accompanying drawings.

### First Embodiment

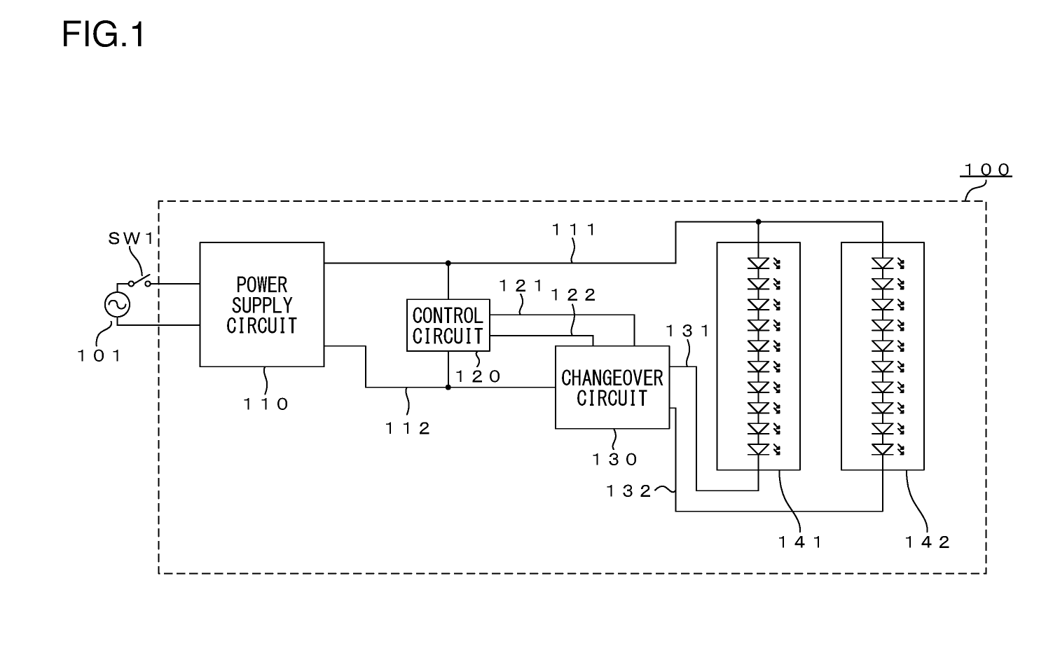

An LED lighting device 100 according to a first embodiment of the invention will be described with reference to FIGS. 1 to 6.

The LED lighting device 100 is an LED lighting device having a function of turning off the supply of power from an AC power supply 101 to the LED lighting device 100 and turning on the supply of power from the AC power supply 101 to the LED lighting device 100 again within a predetermined time period, to thereby change a color temperature of emitted light. An LED lighting device 1200 and an LED lighting device 1400 have many things in common with each other, and thus only differences therebetween will be described.

A power supply voltage for driving a control circuit 120 is applied between an anode line 111 and a cathode line 112. In addition, since the ON/OFF of the supply of power from the AC power supply 101 to the LED lighting device 100 is detected, the control circuit 120 monitors a voltage between the anode line 111 and the cathode line 112 instead of monitoring a voltage of a monitoring line having the same potential as that of one node of the AC power supply 101 when a switch SW1 is in an on-state. When the supply of power from the AC power supply 101 to the LED lighting device 100 is turned off, a power supply circuit 110 cannot drive LED groups 141 and 142, and a voltage between the anode line 111 and the cathode line 112 is set to be lower than a determination threshold value, which results in lights-out. The control circuit 120 regards a state where the voltage between the anode line 111 and the cathode line 112 is set to be lower than the determination threshold value as a state where the supply of power from the AC power supply 101 to the LED lighting device 100 is turned off, thereby controlling a changeover circuit 130.

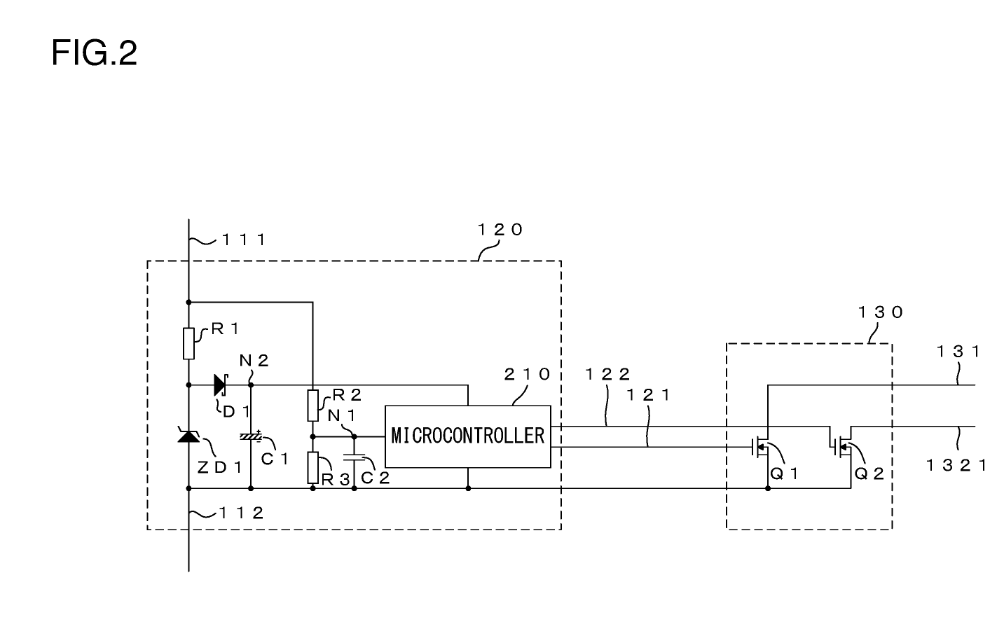

Next, examples of the control circuit 120 and the changeover circuit 130 which are used in the LED lighting device 100 will be described with reference to FIG. 2. A voltage between a power supply node N2 and a reference potential line 172 is used as a power supply voltage for driving a microcontroller 210. The voltage of the power supply node N2 is generated using a resistor R1, a Zener diode ZD1, and a diode D1 on the basis of a voltage between the anode line 111 and the cathode line 112. The diode D1 is provided to prevent back-flow when the supply of power from the AC power supply 101 to the LED lighting device 100 is turned off. In addition, the capacitor Cl is provided in order for the microcontroller 210 to function for a whole even after the supply of power from the AC power supply 101 to the LED lighting device 100 is turned off. For example, the power supply node N2 can be set to have a low voltage of 5 V by using a Zener diode having a Zener voltage of 5.1 V as the Zener diode ZD1 and using a Schottky barrier diode having a relatively low forward voltage as the diode D1. The resistor R1 prevents the power supply node N2 from being set to be in an overvoltage state, and it is necessary to adjust a resistance value of the resistor R1 so as to prevent a current flowing through the path of the resistor R1 and the Zener diode ZD1 from being excessive and to be capable of applying a current sufficient to generate a voltage of the power supply node N2. It is also possible to use current control means using a constant current diode or a transistor instead of the resistor R1.

The voltage between the anode line 111 and the cathode line 112 is divided by a resistor R2 and a resistor R3, and the voltage of the node N1 is set to be the divided voltage of the voltage between the anode line 111 and the cathode line 112. The microcontroller 210 determines that either the LED group 141 or the LED group 142 is driven, that is, the supply of power from the AC power supply 101 to the LED lighting device 100 is turned on, when the voltage of the node N1 is at a level equal to or higher than a predetermined level (the same level as that of a value obtained by resistive division of a determination threshold value by the resistors R2 and R3). In addition, the microcontroller 210 determines that both the LED group 141 and the LED group 142 are not driven, that is, the supply of power from the AC power supply 101 to the LED lighting device 100 is turned off, when the voltage of the node N1 is at a level less than the predetermined level. It is preferable that the node N1 be provided with a low-pass filter in preparation for a case where the LED groups 141 and 142 are intermittently driven by PWM light control, a switching operation of a power supply circuit, or the like or a case where the voltage between the anode line 111 and the cathode line 112 suddenly drops. For this reason, a capacitor C2 is provided between the node N1 and the cathode line 112, and a RC filter functioning as a low-pass filter is constituted by a combination of the capacitor C2 and the resistor R2.

When the supply of power from the AC power supply 101 to the LED lighting device 100 is changed over from an on-state to an off-state, the voltage between the anode line 111 and the cathode line 112 is not necessarily limited to rapidly dropping. In general, the power supply circuit 110 includes an output capacitor having a sufficiently large capacity for the purpose of preventing output ripple or the like, and the discharge of the output capacitor proceeds slowly. In the control circuit 120 illustrated in FIG. 2, the path of the resistor R1 and the Zener diode ZD1 and the path of the resistor R2 and the resistor R3 also have a role in discharging the voltage between the anode line 111 and the cathode line 112. A current flows through the paths even in a lighting state, which results in the loss of power, and thus the loss of power and a response speed of the turn-off of the supply of power have a trade-off relationship. In order to suppress the loss of power in a lighting state, a switching element is added to the paths and is controlled by the microcontroller 210, and thus it is also possible to set the added switching elements to be in an off-state in a lighting state.

The microcontroller 210 determines an LED group to be turned on, on the basis of information of the ON/OFF of the supply of power from the AC power supply 101 to the LED lighting device 100 which is determined from the voltage of the node N1, and controls the changeover circuit 130 by using the voltage of the changeover signal line 121 and the voltage of the changeover signal line 122. The changeover circuit 130 is constituted by two switching elements, and an N-type MOS-FET is used as the two switching elements in the configuration example illustrated in FIG. 2. When the voltage of the changeover signal line 121 is at a High level, the switching element Q1 is set to be in an on-state, and the cathode line 131 is electrically connected to the cathode line 112. Thereby, the LED group 141 is turned on. When the voltage of the changeover signal line 122 is at a High level, the switching element Q2 is set to be in an on-state, and the cathode line 132 is electrically connected to the cathode line 112. That is, the LED group 142 is turned on.

A gate voltage is applied to the MOS-FET within the changeover circuit 130 by a driving voltage of the microcontroller 210. In a Low output, the potential of the cathode line 112 is output, and thus a voltage between a gate and a source of each of the MOS-FETs is set to zero, and the MOS-FET is set to be in an off-state. Since a High output is approximately 5 V on the basis of the voltage of the node N2, that is, the cathode line 112, and a gate threshold voltage of the MOS-FET is approximately 5 V, it is possible to set the MOS-FET to be in an on-state. The microcontroller 210 and the switching elements Q1 and Q2 are operated on the basis of the same potential and use a sufficiently low voltage, and thus insulating means using a photocoupler or the like is not necessary. In a case where a gate voltage of 5 V is not sufficiently, a shift to a higher voltage may be performed using the anode line 111.

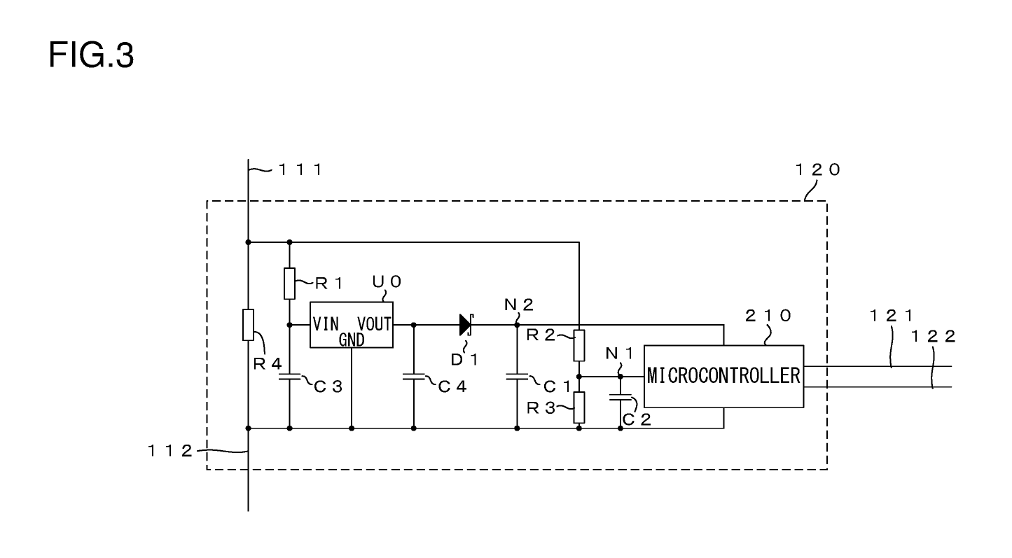

Another example of the control circuit 120 used in the LED lighting device 100 will be described with reference to FIG. 3. The control circuit differs from the control circuit 120 illustrated in FIG. 2 in a method of generating a voltage of the node N2 which is an operation voltage of the microcontroller 210 and in that a resistor R4 is added.

In the control circuit 120 illustrated in FIG. 3, the voltage of the node N2 is mainly generated by a voltage step-down operation of a three-terminal regulator U0. In general, regarding the three-terminal regulator, a certain degree of measure (for example, the addition of an overcurrent protection circuit or an overheat protection circuit, or the like) for preventing a dangerous operation during the occurrence of abnormality is devised, the efficiency of voltage step-down is high, and a maximum output current is high. Therefore, the control circuit 120 illustrated in FIG. 3 is relatively safe as compared to the control circuit 120 illustrated in FIG. 2, and can speed up the generation of a voltage.

As described above, it is possible to rapidly detect that the supply of power from the AC power supply 101 to the LED lighting device 100 is turned off by providing means for rapidly discharging a voltage between the anode line 111 and the cathode line 112 when the supply of power from the AC power supply 101 to the LED lighting device 100 is changed over from an on-state to an off-state, but the resistor R4 is provided only for discharging. When the voltage between the anode line 111 and the cathode 112 is high and a large amount of current flows for discharging, power consumption is also increased, thereby requiring a component having a large rating. When a portion having a role of discharging is focused on the resistor R4 as in the control circuit 120 illustrated in FIG. 3, a component required to have a large rating can be limited to the resistor R4.

In this manner, the control circuit 120 can be configured in various ways in accordance with required characteristics and the like.

As described above, the LED lighting device 100 realizes a function of changing over a color temperature of emitted light with an extremely simple circuit configuration.

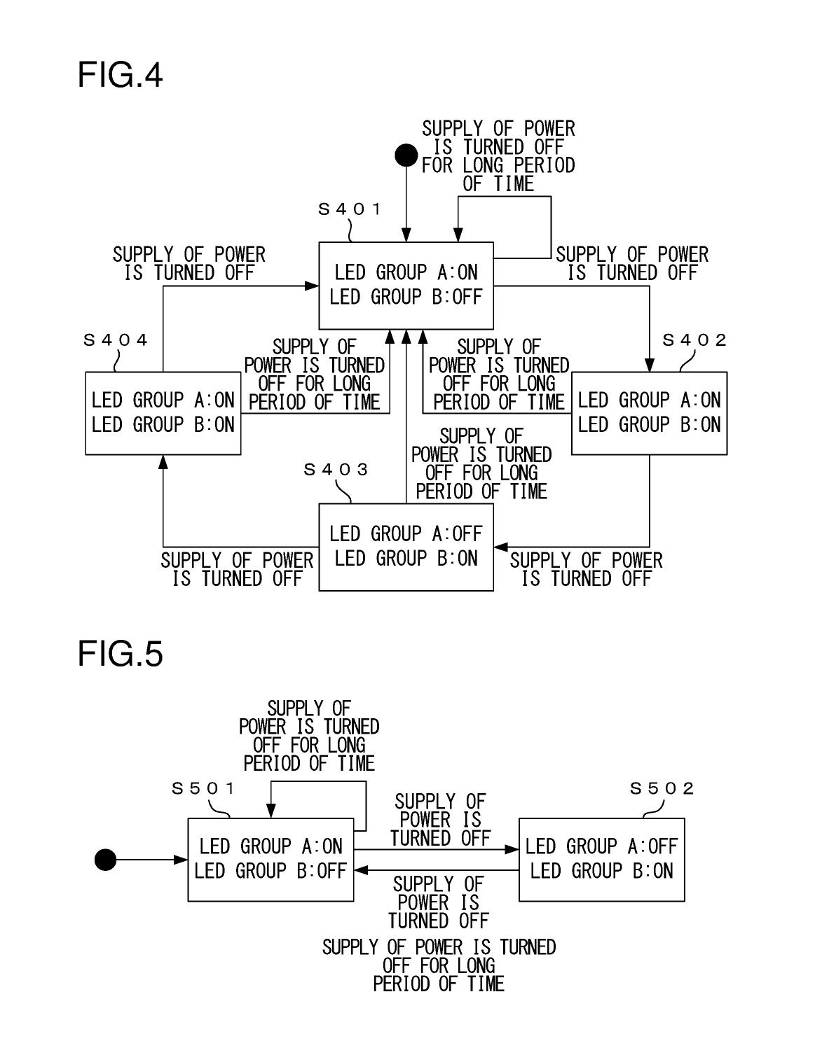

Here, an example of the transition of a state of color temperature changeover which is controlled by the microcontroller 210 will be described with reference to FIG. 4. States S401 to S404 are selection states necessary for an LED group to be turned on, and an LED group selected is an LED group which is turned on when a driving current is applied thereto. An initial selection state is state S401. An LED group A has a color temperature lower than that of an LED group B. One of the LED groups 141 and 142 is the LED group A, and the other is the LED group B.

In state S401, only the LED group A is turned on when the supply of power is turned on, and thus the LED lighting device 100 emits light at a high color temperature. In state S401, the supply of power from the AC power supply 101 to the LED lighting device 100 is turned off by the operation of the power switch SW1, and the state proceeds to state S402 when a first time period elapses. When the supply of power is turned on in this state, lighting is performed in state S402. Since both the LED group A and the LED group B are turned on in state S402, light emitted from the LED lighting device 100 has an intermediate color temperature.

Thereafter, when the same operation is repeated three times, the state proceeds to states S403 and S404 and then returns to state S401. In state S403, only the LED group B is turned on when the supply of power is turned on, and thus light emitted from the LED lighting device 100 has a low color temperature. In state S404, both the LED group A and the LED group B are turned on when the supply of power is turned on similar to state S402, and thus light emitted from the LED lighting device 100 has an intermediate color temperature. That is, the color temperature is looped like high, intermediate, low, intermediate, high, . . . in this order by repeating an operation of turning off the power switch SW1 and then turning on the power switch again within the first time period. When the supply of power from the AC power supply 101 to the LED lighting device 100 is turned off within a second time period longer than the above-mentioned first time period for the transition of a state even in any selection state, the state is set to be state S401 (high color temperature) which is an initial selection state. Therefore, when the supply of power is turned off for a long period of time and is then turned on again, lighting is performed in the selection state of state S401, that is, a color temperature is set to be high.

Next, another example of the transition of a state of color temperature changeover which is controlled by the microcontroller 210 will be described with reference to FIG. 5. States S501 and S502 are selection states necessary for an LED group necessary to be turned on, and an LED group selected is an LED group which is turned on when a driving current is applied thereto. An initial selection state is state S501.

When the supply of power from the AC power supply 101 to the LED lighting device 100 is turned off and a first time period elapses, the state alternately transitions between state S501 and state S502. In state S501, only the LED group A is turned on when the supply of power is turned on, and thus light emitted from the LED lighting device 100 has a high color temperature. In state S502, only the LED group B is turned on when the supply of power is turned on, and thus light emitted from the LED lighting device 100 has a low color temperature. That is, in the example illustrated in FIG. 5, the color temperature is alternately repeated like high, low, high, . . . in this order by repeating an operation of turning off the power switch SW1 and then turning on the power switch again within the first time period. When the supply of power from the AC power supply 101 to the LED lighting device 100 is turned off within a second time period longer than the above-mentioned first time period for the transition of a state even in any selection state, the state is set to be state S501 (high color temperature) which is an initial selection state. Therefore, when the supply of power is turned off for a long period of time and is then turned on again, lighting is performed in the selection state of state S401, that is, a color temperature is set to be high.

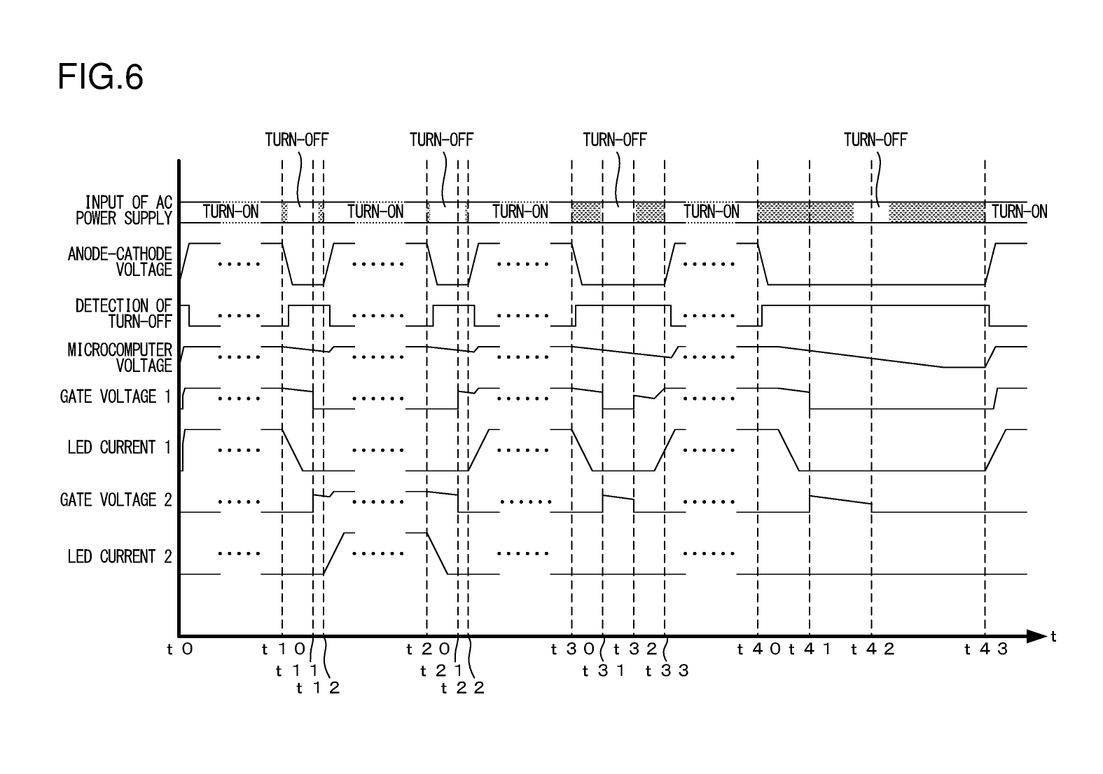

Next, details of the operation of the LED lighting device 100 will be described in time series with reference to FIG. 6. FIG. 6 is a timing chart in a case where the microcontroller 210 operates by the transition of the selection states illustrated in FIG. 5. The LED group A is equivalent to the LED group 141, and the LED group B is equivalent to the LED group 142.

An input of an AC power supply in the drawing indicates the state of ON/OFF of supply of power from the AC power supply 101 to the LED lighting device 100. An anode-cathode voltage in the drawing indicates a voltage between the anode line 111 and the cathode line 112. The detection of turn-off in the drawing indicates a situation where the microcontroller 210 determines a state where the supply of power from the AC power supply 101 to the LED lighting device 100 is turned off, on the basis of the voltage of the node N1, and indicates that a High side regards the supply of power from the AC power supply 101 to the LED lighting device 100 as being turned off. A microcomputer voltage in the drawing is the voltage of the node N2. A gate voltage 1 in the drawing is a gate voltage of the switching element Q1. An LED current 1 in the drawing is a current that flows to the LED group 141. A gate voltage 2 in the drawing is a gate voltage of the switching element Q2. An LED current 2 in the drawing is a current that flows to the LED group 142.

The supply of power from the AC power supply 101 to the LED lighting device 100 is changed over from an off-state to an on-state at time t0. The anode-cathode voltage rises, and becomes constant so as to be set to be a voltage for applying a predetermined current to an LED group. In addition, when the anode-cathode voltage has a value equal to or greater than a determination threshold value, the detection of turn-off is changed over from a High level to a Low level. A microcomputer voltage rises in accordance with an increase in the anode-cathode voltage. A selection state when the rise in the microcomputer voltage is completed is set to be state S501 illustrated in FIG. 5. The gate voltage 1 is equal to the High level of the microcontroller 210, that is, the microcomputer voltage, and the switching element Q1 is set to be in an on-state. The gate voltage 2 is equal to the Low level of the microcontroller 210, that is the voltage of the cathode line 112, and the switching element Q2 is set to be in an off-state. All LED driving currents which are output from the power supply circuit 110 are set to be the LED current 1, and the LED current 2 is set to zero by the states of the switching elements.

The supply of power from the AC power supply 101 to the LED lighting device 100 is changed over from an on-state to an off-state at time t10, and the supply of power from the AC power supply 101 to the LED lighting device 100 is turned on again at time t12. When the anode-cathode voltage drops from time t10 and is set to be less than a determination threshold value, the detection of turn-off is set to be at a High level, and the state proceeds to state S502 illustrated in FIG. 5 at time t11. The gate voltage 1 is changed over from a High level to a Low level at time t11, the gate voltage 2 is changed over from a Low level to a High level, the switching element Q1 is changed from an on-state to an off-state, and the switching element Q2 is changed over from an off-state to an on-state. When the supply of power from the AC power supply 101 to the LED lighting device 100 is turned on again at time t12, the power supply circuit 110 operates again. However, since the switching element Q1 is set to be in an off-state and the switching element Q2 is set to be in an on-state, the LED current 1 is set to a zero value, and all LED driving currents which are output from the power supply circuit 110 are set to be the LED current 2. The microcomputer voltage is maintained in a voltage range in which the microcontroller 210 is operable, between time t0 and time t12.

Next, the supply of power from the AC power supply 101 to the LED lighting device 100 is changed over from an on-state to an off-state at time t20, and the supply of power from the AC power supply 101 to the LED lighting device 100 is turned on again at time t22. The color temperature is changed over at time t21, and the state returns to state S501 illustrated in FIG. 5 from state S502 illustrated in FIG. 5. The changeover of the gate voltage 1 and the gate voltage 2 is opposite to the changeover between time t10 and time t12.

Next, the supply of power from the AC power supply 101 to the LED lighting device 100 is changed over from an on-state to an off-state at time t30, and the supply of power from the AC power supply 101 to the LED lighting device 100 is turned on again at time t33. A period of time between time t30 and time t33 is longer than a first time period, and the switching element Q1 and the switching element Q2 are respectively set to be in an off-state and an on-state once (time t31). However, when the supply of power from the AC power supply 101 to the LED lighting device 100 is turned off for a second time period which is longer than the first time period at time t32, the switching element Q1 is set to be in an on-state and the switching element Q2 returns to an off-state. The microcomputer voltage is also maintained in a voltage range in which the microcontroller 210 is operable, between time t30 and time t33.

Next, the supply of power from the AC power supply 101 to the LED lighting device 100 is changed over from an on-state to an off-state at time t40, and the supply of power from the AC power supply 101 to the LED lighting device 100 is set to be in an on-state again at time t43. A period of time between time t40 and time t43 is longer than a period of time between time t30 and time t33, and the microcomputer voltage cannot maintain the operation of the microcontroller 210. In this case, when the supply of power from the AC power supply 101 to the LED lighting device 100 is set to be in an on-state again at time t43, state S501 illustrated in FIG. 5 is set to be an initial selection state, and thus there is no apparent difference from the operation at time t33. That is, when a period of time for which the supply of power from the AC power supply 101 to the LED lighting device 100 is turned off at time t40 is continued for the second time period which is longer than the first time period, there are two cases of a case where the state transitions to state S501 under the control of the microcontroller 210 and a case where the microcontroller 210 is initialized and the state transitions to state S501, but there is no difference in operation in any case.

### Second Embodiment

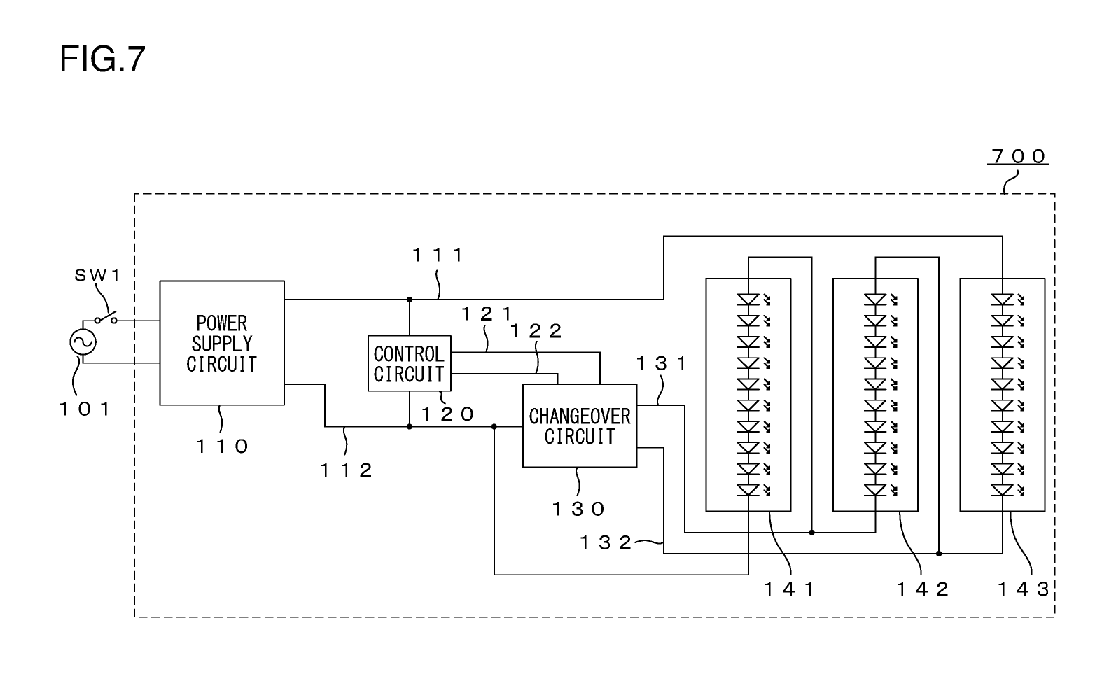

An LED lighting device 700 according to a second embodiment of the invention will be described with reference to FIG. 7.

The LED lighting device 700 is an LED lighting device having a function of changing the brightness of emitted light by turning off the supply of power from an AC power supply 101 to the LED lighting device 100 and turning on the supply of power from the AC power supply 101 to the LED lighting device 100 again within a predetermined time period. The LED lighting device and the LED lighting device 100 have many things in common with each other, and thus only differences therebetween will be described.

A changeover circuit 130 changes over first to third states under the control of a control circuit 120.

In the first state, the changeover circuit 130 does not electrically connect both a cathode line 131 and a cathode line 132 to a cathode line 112. Thereby, a state where three LED groups 143, 142, and 141 are connected to each other in series in order from an anode side is set. When the supply of power is turned on, driving is performed with a predetermined current. However, all of the LED groups are driven with a predetermined current, and thus have the maximum brightness.

In the second state, the changeover circuit 130 electrically connects the cathode line 131 and the cathode line 112 to each other, and does not electrically connect the cathode line 132 and the cathode line 112 to each other. Thereby, a state where two LED groups 143 and 142 are connected to each other in series in order from the anode side is set, and the LED groups are driven with a predetermined current when the supply of power is turned on.

In the third state, the changeover circuit 130 electrically connects the cathode line 132 and the cathode line 112 to each other. Thereby, a state where only the LED group 143 is connected between the anode line 111 and the cathode line 112 is set, and the LED group is driven with a predetermined current when the supply of power is turned on.

As described above, it is possible to control the brightness of the LED lighting device 700 during lighting, in order of the first state, the second state, and the third state. The LED lighting device is a LED lighting device that changes over brightness by the operation of a power switch SW1 by which the control circuit 120 controls the voltages of changeover signal lines 121 and 122 in accordance with an on-state/off-state of the supply of power from the AC power supply 101 to the LED lighting device 700. For example, in a case where the changeover circuit 130 is configured as illustrated in FIG. 2, the first state is set when both the voltages of the changeover signal lines 121 and 122 are at a Low level, the second state is set when the voltage of the changeover signal line 121 is at a High level and the voltage of the changeover signal line 122 is at a Low level, and the third state is set when the voltage of the changeover signal line 122 is at a High level. When an operation of the power switch SW1 for turning off the supply of power from the AC power supply 101 to the LED lighting device 700 and turning on the supply of power from the AC power supply 101 to the LED lighting device 700 again within a first time period is repeated three times from the first state, the state transitions to the second state and the third state and then returns to the lighting in the first state.

### Third Embodiment

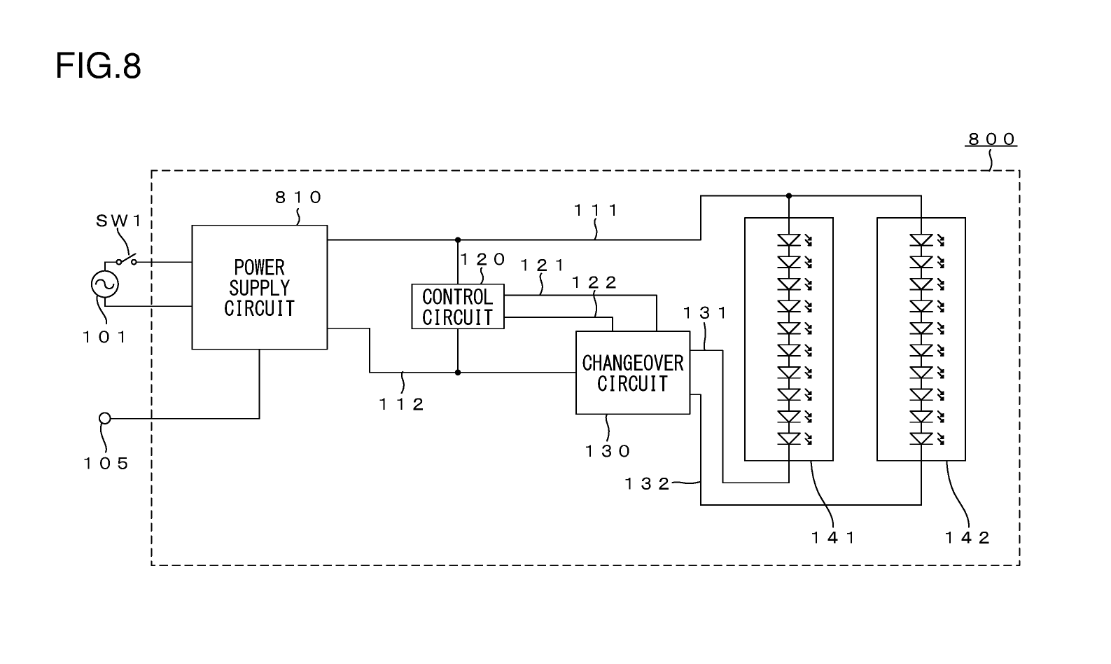

An LED lighting device 800 according to a third embodiment of the invention will be described with reference to FIG. 8.

The LED lighting device 800 is an LED lighting device having a light control function of allowing the brightness of emitted light to be changeable and a function of changing a color temperature of emitted light by turning off the supply of power from an AC power supply 101 to the LED lighting device 100 and turning on the supply of power from the AC power supply 101 to the LED lighting device 100 again within a predetermined time period. The LED lighting device and the LED lighting device 100 have many things in common with each other, and thus only differences therebetween will be described.

There are two main light control methods of an LED lighting device. A first light control method is PWM light control, and is a method of changing the brightness of emitted light in accordance with a duty ratio of a pulse signal. A second light control method is phase light control, and is a method of transmitting information of light control to the LED lighting device by performing phase control of an AC voltage, which is output from an AC power supply which is an external power supply, and changing the brightness of light emitted by the lighting device in accordance with the information.

A power supply circuit 810 used in the LED lighting device 800 illustrated in FIG. 8 corresponds to PWM light control, and adjusts the value of an output current (LED driving current) in accordance with a PWM light control signal which is supplied to an external input terminal 105 from the outside.

In this embodiment, it is possible to change the brightness of lighting by PWM light control. However, in a case where an LED is turned on, a voltage between an anode line 111 and a cathode line 112 is set to be more than a certain degree of voltage, and thus it is possible to realize the changeover of a color temperature by configuring the stage subsequent to the power supply circuit 810 in exactly the same manner as the LED lighting device 100.

Although not particularly shown in the drawing, in a case of phase light control, a phase control type light controller is provided between an AC power supply and an LED lighting device. Also in this case, when the supply of power from the AC power supply to the LED lighting device is turned on, there is a difference in the degree of brightness of lighting, and the LED is turned on. For this reason, a voltage between an anode line and a cathode line is set to be a certain degree of voltage. In addition, when the supply of power from the AC power supply to the LED lighting device is turned off, a voltage between the anode line and the cathode line drops. That is, focusing on the voltage between the anode line and the cathode line, there is no difference from the LED lighting device 100. Therefore, it is also possible to cope with phase light control with the same configuration as that of the LED lighting device 100. The power supply circuit 110 may be just a power supply circuit applicable to phase light control, that is, a power supply circuit that adjusts the value of an output current (LED driving current) in accordance with an input voltage having subjected to phase control.

As described above, the invention can be applied in both a lighting device applicable to PWM light control and a lighting device applicable to phase light control without impairing the light control functions.

### Fourth Embodiment

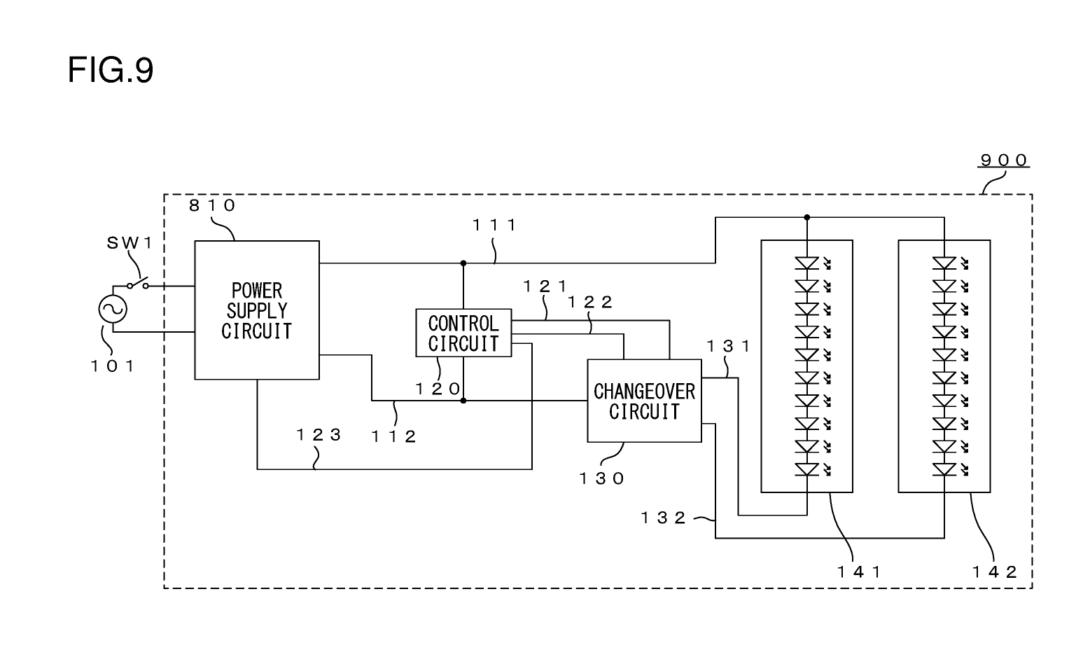

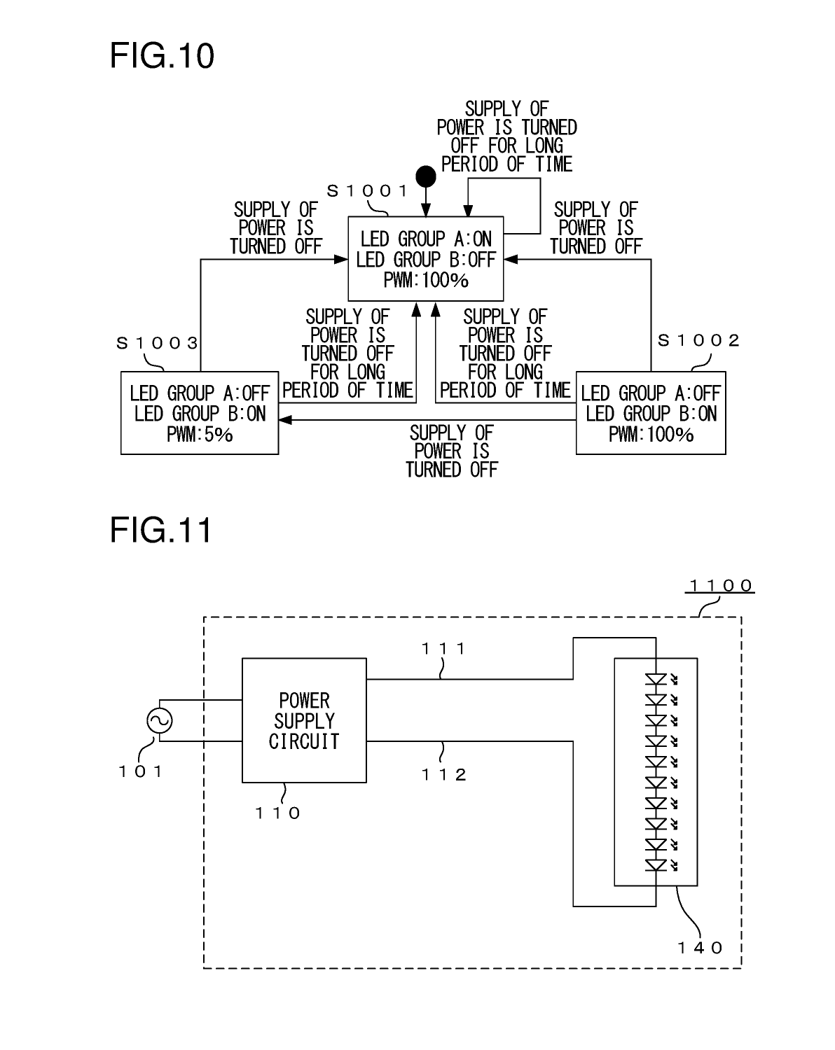

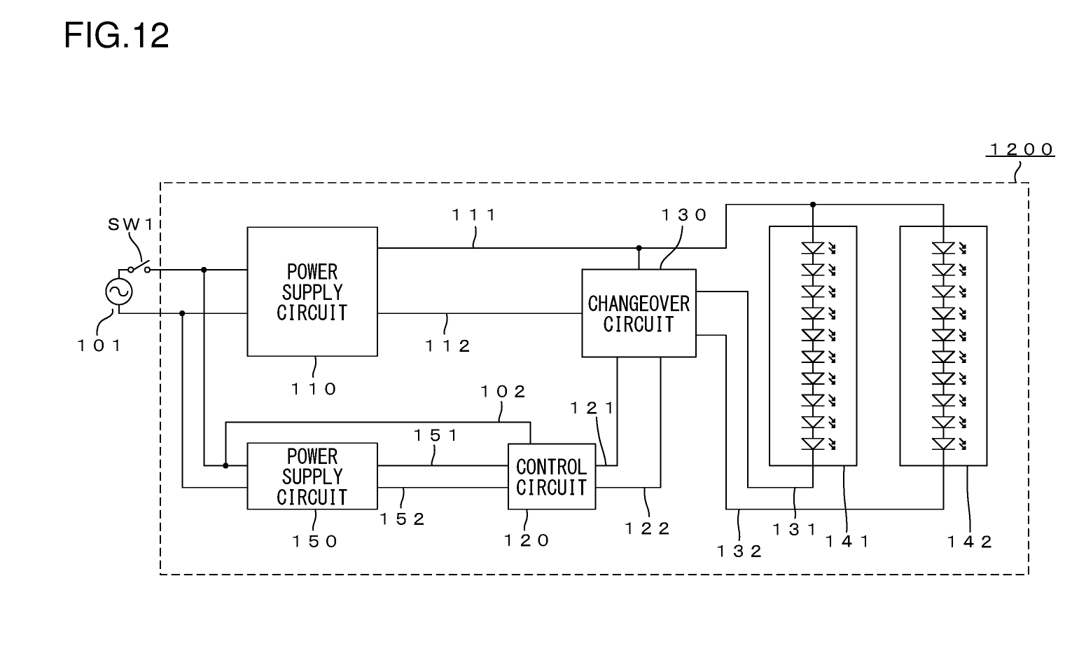

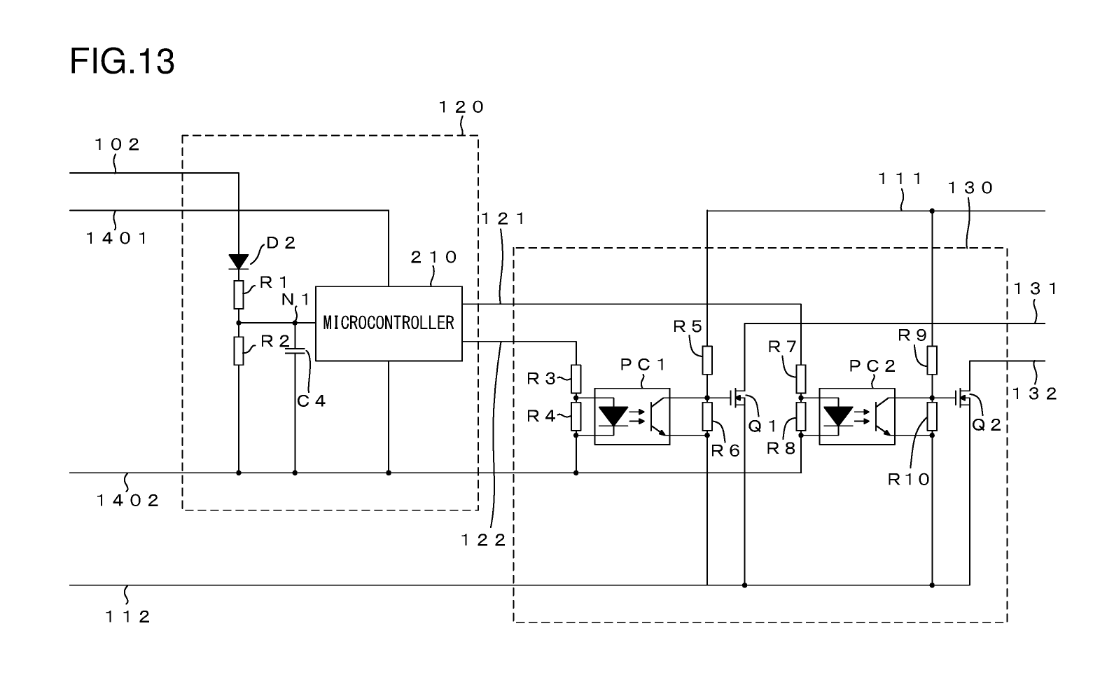

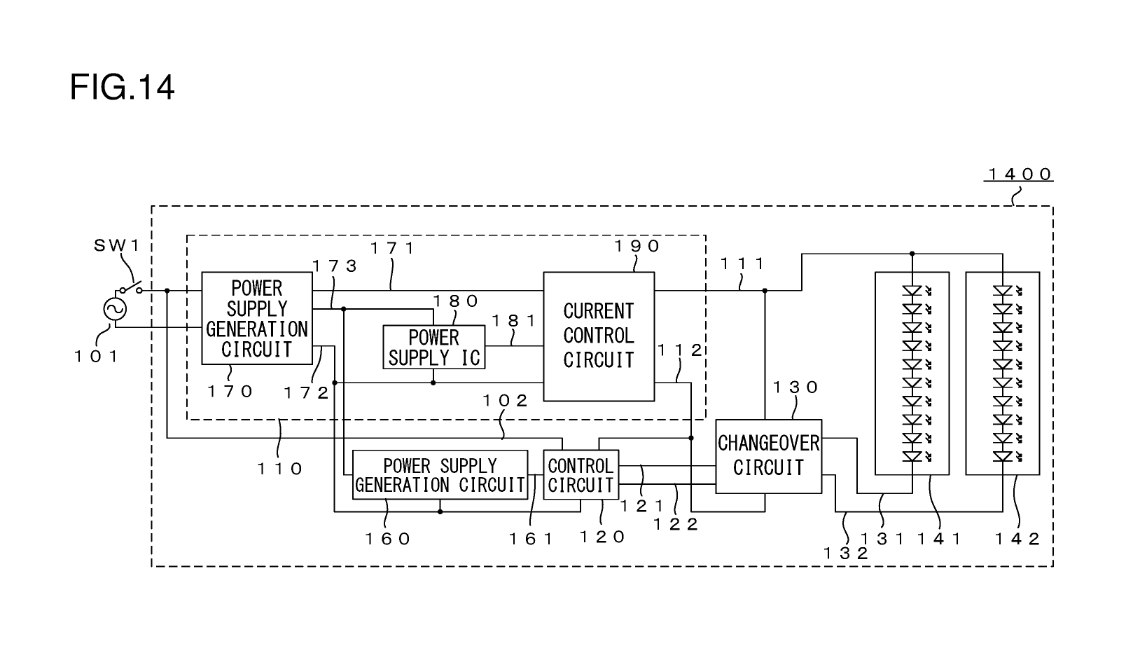

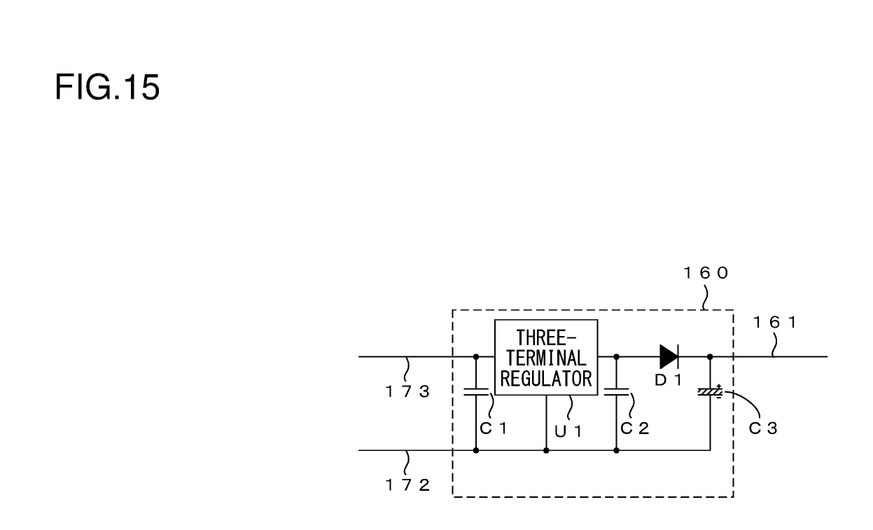

An LED lighting device 900 according to a fourth embodiment of the invention will be described with reference to FIGS. 9 and 10

In household ceiling lights, a lighting device including an all-night light is the mainstream. The all-night light has a low color temperature, and has an extremely low brightness as compared to a general light. That is, since the turn-on of a small LED single body only has to be controlled by a simple logic circuit, it is not necessary to perform complex control as in a main light, and the control is generally performed through a completely different process. It is difficult to apply the invention to the lighting device including an all-night light which is configured in this manner. This is because there is a need for a configuration in which the ON/OFF not only of a main lighting unit but also of the all-night light has to be monitored and a driving power of a control circuit is obtained from both of them. Therefore, a configuration or a necessary additional circuit becomes complex. Consequently, the LED lighting device 900 illustrated in FIG. 9 is configured to easily provide an alternative of an all-night light.

The LED lighting device 900 is configured such that an LED group having a low color temperature is turned on with a low brightness so as to be used as a substitute for an all-night light, instead of preparing a dedicated LED as an all-night light. The control circuit 120 also generates a voltage to be applied to a PWM signal line 123, in addition to a voltage to be applied to a changeover signal line 121 and a voltage to be applied to a changeover signal line 122. The LED lighting device 900 uses a power supply circuit 810 applicable to PWM light control similar to the LED lighting device 800. However, a PWM light control signal received by the power supply circuit 810 is generated by the control circuit 120 without being supplied from the outside, unlike the LED lighting device 800. With such a configuration, the control circuit 120 can perform the PWM light control of LED driving.

Here, an example of the transition of a state of color temperature changeover which is controlled by the control circuit 120 will be described with reference to FIG. 10. States S1001 to S1003 are selection states necessary for an LED group to be turned on, and an LED group selected is an LED group which is turned on when a driving current is applied thereto. An initial selection state is state S1001. An LED group A has a color temperature lower than that of an LED group B. One of the LED groups 141 and 142 is the LED group A, and the other is the LED group B.

In state S1001, only the LED group A is selected, and only the LED group A is turned on by 100% PWM light control when the supply of power is turned on. That is, lighting is performed at a high color temperature and with a high brightness. In state S1001, the supply of power from an AC power supply 101 to the LED lighting device 900 is turned off by the operation of a power switch SW1, and the state proceeds to state S1002 when a first time period elapses. In state S1002, only the LED group B is selected, and only the LED group B is turned on by 100% PWM light control when the supply of power is turned on. That is, lighting is performed at a low color temperature and a high brightness. Further, when the above-described operation of the power switch SW1 is performed in state S1002, the state proceeds to state S1003. In state S1003, only the LED group B is selected, and only the LED group B is turned on by 5% PWM light control when the supply of power is turned on. That is, lighting is performed with a low brightness. The state S1003 serves as an all-night light.

In any selection state, the state proceeds to state 1001 when the supply of power from the AC power supply 101 to the LED lighting device 900 is turned off for a long period of time exceeding a second time period, and then lighting is performed at a high color temperature and with a high brightness when the supply of power from the AC power supply 101 to the LED lighting device 900 is turned on again.

The LED lighting device 900 can realize functions as an alternative of a lighting device including an all-night light by the above-described method.

Meanwhile, this embodiment can also be implemented in combination with the third embodiment. In a case where contents of a PWM light control signal generated by the control circuit 120 and contents of a PWM light control signal supplied from the outside do not conform to each other, the power supply circuit 810 may prioritize either of the contents. For example, the PWM light control signal supplied from the outside may be prioritized in states S1001 and S1002, and the PWM light control signal generated by the control circuit 120 may be prioritized in state S1003. According to this example, 100% light control may not be performed in states S1001 and S1002.

<Others>

As described above, the embodiments of the invention have been described. However, the scope of the invention is not limited thereto, and various modifications can be made without departing from the scope of the invention.

For example, in the above-described embodiments of the invention, a case where an external power supply supplying power to a lighting device is an AC power supply has been described. However, also in a case where the external power supply supplying power to the lighting device is a DC power supply, the same effects are obtained by the same configuration (here, the operation of the power supply circuit 120 is changed from AC/DC conversion to DC/DC conversion).

In addition, for example, in the above-described embodiments of the invention, an example of the changeover of LED groups having two types of color temperatures has been described with respect to the changeover of a color temperature. However, the changeover of LED groups having three types or more color temperatures can also be performed with the same configuration. In addition, the changeover of brightness and the changeover of a color temperature can also be easily performed in combination with each other.

In addition, for example, in the above-described embodiments of the invention, an LED is used as a light source, but a light emitting element (for example, an organic EL element or the like) other than an LED may be used as a light source.

The above-described lighting device is configured (first configuration) to include a plurality of light sources (141, 142, 143), a power supply circuit (110, 810) that generates a power supply voltage on the basis of a voltage which is output from an external power supply (101), and a control circuit (120) which is driven by the power supply voltage. The lighting device is configured such that the control circuit detects a drop in the power supply voltage, controls lighting states of the plurality of light sources on the basis of the detection and the power supply voltage is supplied to all or a portion of the plurality of light sources.

With such a configuration, it is not necessary to add or change a power supply circuit for the control circuit, and thus a simple configuration is obtained. In addition, the turn-off of the supply of power from the external power supply to the LED lighting device can be determined on the basis of a drop in the power supply voltage, and thus it is possible to realize the transition of lighting states of the plurality of light sources by the ON/OFF of the supply of power from the external power supply to the LED lighting device.

In the lighting device having the above-described first configuration, it is preferable to adopt a configuration (second configuration) in which the control circuit preferably includes a detection unit (210, R2, R3, C2) that detects a drop in the power supply voltage and a voltage generation unit (R1, ZD1, D1, C1, C3, U0, C4) that generates a power supply voltage for the detection unit for driving the detection unit on the basis of the power supply voltage, and the voltage generation unit include a capacity (C1) for holding the power supply voltage for the detection unit.

With such a configuration, even when the supply of power from the external power supply to the LED lighting device is turned off, it is possible to operate the control circuit for a while.

In the lighting device having the above-described first or second configuration, it is preferable to adopt a configuration (third configuration) in which the control circuit includes a discharging element (R4) that discharges the power supply voltage and is not included in the detection unit and the voltage generation unit.

With such a configuration, it is possible to rapidly detect the turn-off of the supply of power from the external power supply to the LED lighting device. In addition, with such a configuration, a component requiring a large rating can also be limited to being a discharging element that discharges a power supply voltage and is not included in a detection unit and a voltage generation unit.

In the lighting device having any one of the above-described first to third configurations, it is preferable to adopt a configuration (fourth configuration) in which the control circuit sets selection states of the plurality of light sources to be a first selection state in an initial state, makes the selection states of the plurality of light sources transition to another selection state in a case where a first time period elapses after a drop in the power supply voltage is detected, and sets the selection states of the plurality of light sources to be the first selection state in a case where a second time period longer than the first time period elapses after a drop in the power supply voltage is detected.

With such a configuration, any selection state can be set to be the first selection state (initial selection state) by a simple operation.

In the lighting device having any one of the above-described first to fourth configurations, it is preferable to adopt a configuration (fifth configuration) in which the power supply circuit adjusts the value of an output current in accordance with a light control signal.

With such a configuration, for example, it is possible to perform light control from the outside.

In the lighting device having the fifth configuration, it is preferable to adopt a configuration (sixth configuration) in which the control circuit generates the light control signal.

With such a configuration, for example, it is possible to realize functions as an alternative of a lighting device including an all-night light.

In the lighting device having the sixth configuration, it is preferable to adopt a configuration (seventh configuration) in which the light control signal is supplied from the outside, and the power supply circuit prioritizes either of the contents of the light control signal generated by the control circuit the contents of the light control signal supplied from the outside in a case where the contents do not conform to each other.

With such a configuration, for example, it is possible to realize light control from the outside and functions as an alternative of a lighting device including an all-night light.

### REFERENCE SIGNS LIST

100, 700, 800, 900 LED LIGHTING DEVICE ACCORDING TO THE INVENTION

1100, 1200, 1400 LED LIGHTING DEVICE OF THE RELATED ART

101 AC POWER SUPPLY

102 MONITORING LINE

161, 171, 173 POWER SUPPLY LINE

110, 150, 810 POWER SUPPLY CIRCUIT

111 ANODE LINE

112 CATHODE LINE

120 CONTROL CIRCUIT

121, 122 CHANGEOVER SIGNAL LINE

130 CHANGEOVER CIRCUIT

131, 132 CATHODE LINE

140, 141, 142, 143 LED GROUP

160, 170 POWER SUPPLY GENERATION CIRCUIT

172 REFERENCE POTENTIAL LINE

190 CURRENT CONTROL CIRCUIT

210 MICROCONTROLLER

SW1 POWER SWITCH

1-5. (canceled)

6. A lighting device comprising:
a plurality of light sources that have different characteristics of emitted light;
a power supply circuit that generates a power supply voltage on the basis of a voltage which is output from an external power supply; and
a control circuit that is driven by the power supply voltage,
wherein the control circuit includes a detection unit that detects a drop in the power supply voltage, and a voltage generation unit that generates a power supply voltage for the detection unit for driving the detection unit on the basis of the power supply voltage,
wherein the voltage generation unit includes a voltage dropping unit and a voltage holding unit,
wherein the control circuit detects a drop in the power supply voltage by the detection unit and controls lighting states of the plurality of light sources on the basis of the detection,
wherein the control circuit is operable by only the power supply voltage for the detection unit, and has a function of performing setting to an initial selection state by a drop in the power supply voltage, and
wherein the power supply voltage is supplied to all or a portion of the plurality of light sources.

7. The lighting device according to claim 6,
wherein the voltage generation unit has a capacity as the voltage holding unit, and
wherein a time period for which the control circuit is capable of being driven with the capacity is longer than a time period for which the detection unit detects a drop in the power supply voltage.

8. The lighting device according to claim 6,
wherein the control circuit sets selection states of the plurality of light sources to be a first selection state in an initial state, makes the selection states of the plurality of light sources transition to another selection state when a first time period elapses after a drop in the power supply voltage is detected, and sets the selection states of the plurality of light sources to be the first selection state when a second time period longer than the first time period elapses after a drop in the power supply voltage is detected or when the control circuit is reset by a drop in the power supply voltage for the detection unit.

9. The lighting device according to claim 6,
wherein the power supply circuit adjusts a value of an output current in accordance with a light control signal.

10. The lighting device according to claim 9,
wherein the control circuit generates the light control signal.
